(19) United States
(12) Patent Application Publication
(10) Pub. No.: US 2011/0030252 A1
(43) Pub. Date: Feb. 10, 2011

(54) Illuminated Point of Sale Signage System

(76) Inventor: Dimitrios Marinakis, Montreal (CA)

Correspondence Address: DOWELL & DOWELL P.C., 103 Oronoco St., Suite 220, Alexandria, VA, 22314, US

(21) Appl. No.: 12/850,963

(22) Filed: Aug. 5, 2010

(30) Foreign Application Priority Data
Aug. 7, 2009 (CA) 2674860

(51) Int. Cl. G09F 13/00; F21L 4/08

(52) U.S. Cl. 40/549; 362/183; 40/541

(57) ABSTRACT

An illuminated point of sale sign is disclosed which includes a frame, a lighting system and a battery electrically connected to the lighting system, the lighting system and the battery being disposed within the frame, and a light sensor disposed outside the frame and electrically connected to the lighting system and the battery. The frame includes projections which define receptacle perimeters adapted to receive and accommodate existing real estate signs made of thin corrugated plastic or lexan.

### CROSS-REFERENCE

The present application claims priority to Canadian Patent Application No. 2,674,860 filed on Aug. 7, 2009, the entirety of which is incorporated herein by reference.

### FIELD OF THE INVENTION

The present invention relates generally to illuminated signs used for advertising and more specifically to a portable illuminated Point of sale signage system.

### BACKGROUND OF THE INVENTION

Existing real estate signs for advertising are not typically illuminated at night thereby reducing their intended role since the signs are only effective when they are seen by prospective buyers which is not the case at night if there is insufficient light available at the point of sale location.

U.S. Pat. No. 7,357,527 provides one solution to this problem in the form of a lighting module that can be mounted on top of the support of a real estate advertising sign. The lighting module includes a pair of illuminating members that extend on opposite sides of the sign and direct light onto the advertising areas of the real estate sign. One drawback of this solution is that the mountable lighting module must be mounted to a support structure having a specific width otherwise the lighting module cannot be installed. Typical real estate signs are often made of thin panels which cannot support the lighting module. Secondly, the lighting module is an add-on and can be removed easily which inevitably leads to thefts of the lighting module, increased cost for replacement and of course loss of sales opportunity while the real estate sign is not lit and prospective buyers pass by at night without noticing the advertising sign.

U.S. Pat. No. 7,549,245 provides another solution to this problem in the form of a complete illuminated sign system including a support structure housing a battery pack, a solar panel and a transformer, and a hanging sign structure including an internal lighting source and a pair of light permeable panels made of glass, plastic, or the likes. One drawback of this solution is that the entire system must be used in order to be effective. The support structure is essential as well as the hanging sign structure and the light permeable panels adapted for the system. The entire system may be expansive and previously made real estate sign become useless and must be discarded.

Therefore, there is a need for a self sufficient illuminated point of sale signage system adapted to integrate existing advertising panels.

### SUMMARY OF THE INVENTION

It is an object of the present invention to ameliorate at least some of the inconveniences present in the prior art.

It is also an object of the present invention to provide a self sufficient illuminated point of sale signage system adapted to integrate existing advertising panels.

In one aspect, the invention provides an illuminated point of sale sign comprising: a frame, a lighting system and a battery electrically connected to the lighting system, the lighting system and the battery being disposed within the frame, and a light sensor disposed outside the frame and electrically connected to the lighting system and the battery; the frame including projections which define a receptacle perimeter adapted to receive and accommodate an existing advertising sign made of thin corrugated plastic or lexan.

In a further aspect, the illuminated point of sale sign further comprises a solar cell disposed above the frame and electrically connected to the battery for recharging the battery during daylight.

In an additional aspect, the frame includes horizontal upper and lower rails and vertical side rails, each rail being an extruded profile including the projections which define inner grooves.

In an additional aspect, the illuminated point of sale sign further comprises a substitute rear panel adapted for attaching the illuminated point of sale sign to a vertical surface.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a right side perspective view of the point of sale signage system in accordance with one embodiment of the invention;

FIG. 2 is a front elevational view of the frame structure of the point of sale signage system shown in FIG. 1 without the sign panels;

FIG. 3 is a right side perspective view of the main portion of the point of sale signage system shown in FIG. 1 with one side rail removed;

FIG. 4 is a right side perspective view of the main portion of the point of sale signage system shown in FIG. 3 showing the sign panels insertion path;

FIG. 5 is a cross-sectional view taken at line 5-5 of FIG. 2 showing the inside portion of the left side rail and cross-section of the upper and lower rails;

FIG. 6 is an enlarged view of the cross-section of the upper rail shown in FIG. 5;

FIG. 7 is an enlarged view of the cross-section of the lower rail shown in FIG. 5;

FIG. 8 is an enlarged view of the detail 8 shown in FIG. 3;

FIG. 9 is an enlarged view of the detail 9 shown in FIG. 3;

FIG. 10 is a cross-sectional view taken at line 10-10 of FIG. 2 showing the inside portion of the upper rail and cross-sections of the left and right side rails;

FIG. 11 is a cross-sectional view taken at line 11-11 of FIG. 2 showing the inside portion of the lower rail and cross-sections of the left and right side rails;

FIG. 12 is an elevational view of a substitute rear panel adapted for attachment to a vertical surface;

FIG. 13 is a left frontal perspective view of the point of sale signage system in accordance with second embodiment of the invention;

FIG. 14 is a left rear perspective view of the point of sale signage system shown in FIG. 14;

FIG. 15 is a right perspective view of the rear panel of the point of sale signage system shown in FIGS. 13 and 14; and

FIG. 16 is an enlarged perspective view of the rear panel shown in FIG. 15.

### DETAILED DESCRIPTION OF THE PREFERRED EMBODIMENTS

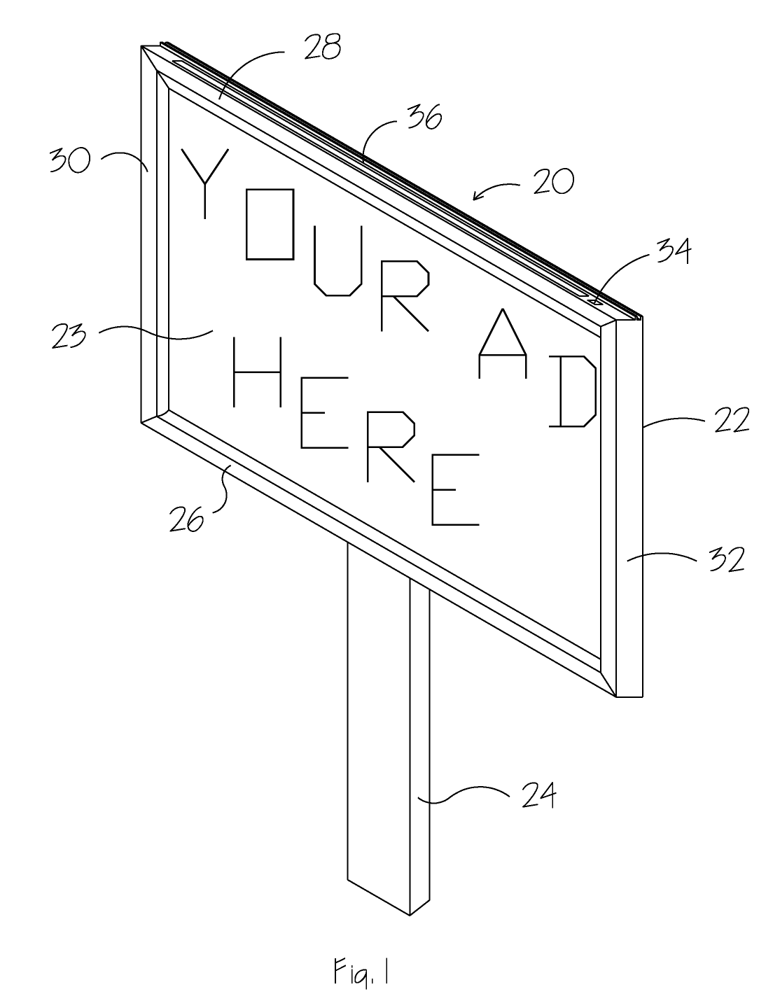

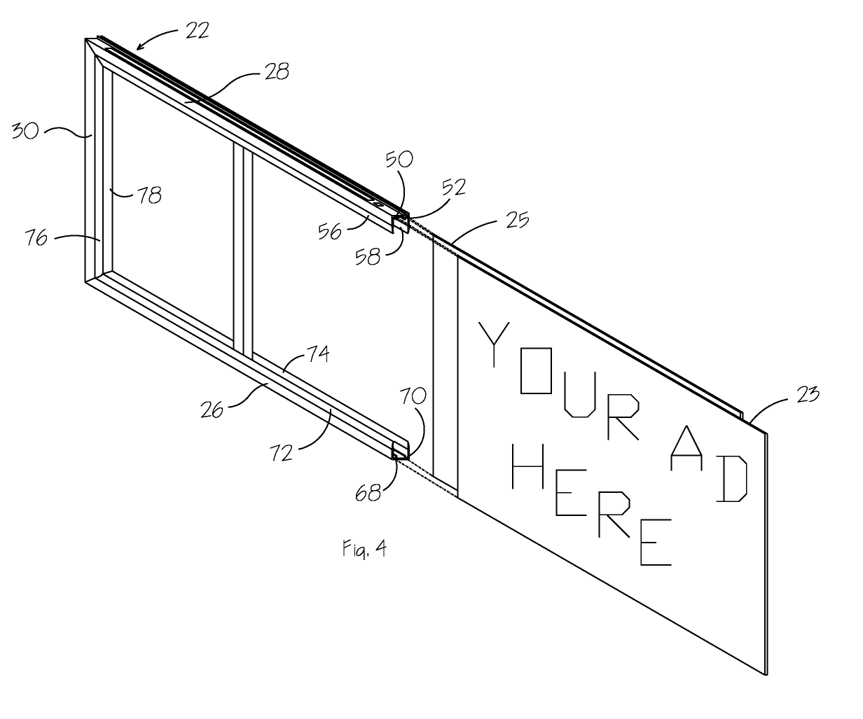

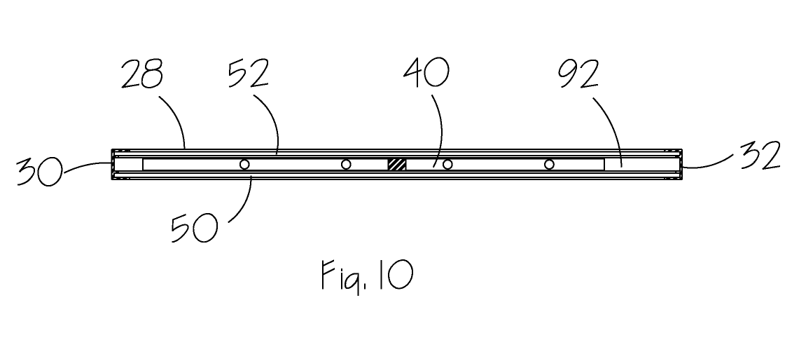

Referring to FIG. 1, there is illustrated a point of sale signage system 20 in accordance with one embodiment of the invention. The point of sale signage system 20 includes a rectangular frame 22 adapted to secure at least one advertising sign panel 23 facing forward and optionally a second advertising sign panel 25 (FIG. 4) facing in the opposite direction. The rectangular frame 22 includes horizontal lower rail 26 and upper rail 28, and two vertical side rails 30 and 32. A support post 24 is connected to the lower rail 26 and is adapted to secure the point of sale signage system 20 to the ground. The point of sale signage system 20 is provided with a lighting system 40 (FIGS. 10, 11, 12) located inside the rectangular frame 22 such that the advertising sign panels 23 and 25 are illuminated at night. Existing real estate advertising signs are not typically illuminated at night, thereby reducing their intended role because real estate signs are effective only when there is sufficient light available. The point of sale signage system 20 being illuminated when there is insufficient light available attracts attention of prospective buyer to the point of sale signage system 20 at night, thereby increasing the efficiency of the real estate advertising.

As shown in FIG. 1, the upper rail 28 includes a light sensor 34 and a solar cell 36. The solar cell 36 is connected to a battery pack 42 located inside the rectangular frame 22 such that the battery pack may be charged during the day. An integrated circuitry is provided between the light sensor 34, the solar cell 36, the lighting system 40 and the battery pack 42 which controls the charging process of the battery pack when during the day and cuts off the charging process when the battery pack is fully charged so that the battery pack does not become overcharged. When there is insufficient light, the light sensor 34 sends a signal to the integrated circuitry which in turn sends power from the battery pack 42 to the lighting system 40 located inside the rectangular frame 22 to illuminate the advertising sign panels 23 and 25 of the point of sale signage system 20.

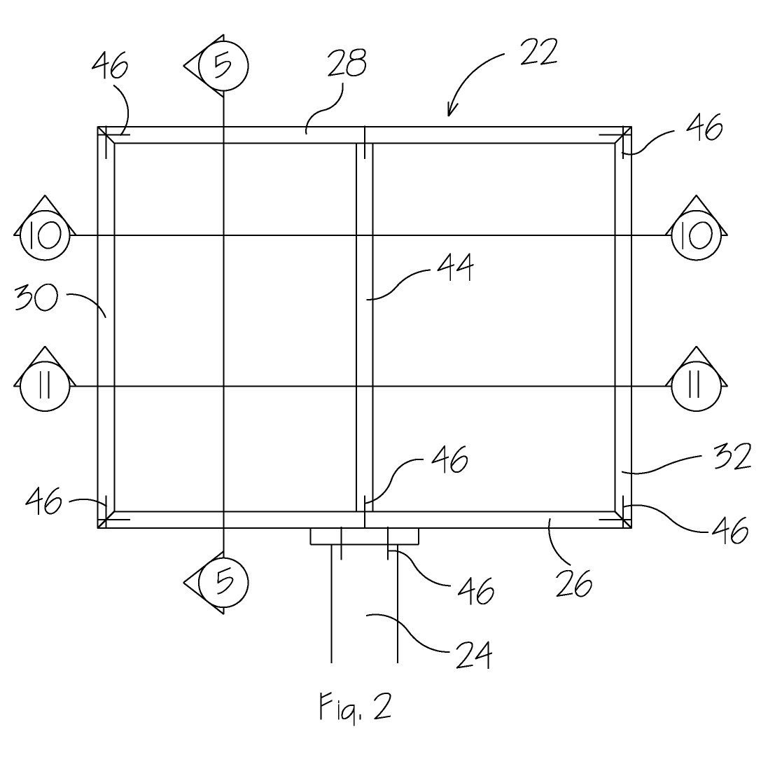

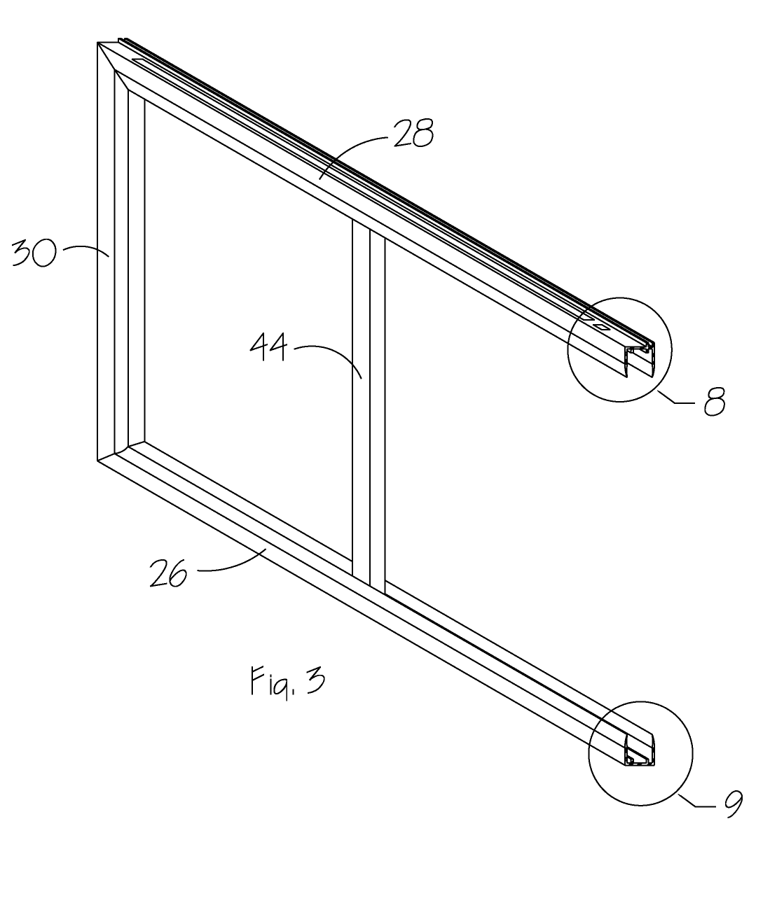

With reference to FIG. 2, the rectangular frame 22 includes horizontal lower rail 26 and upper rail 28, and two vertical side rails 30 and 32 made of extruded PVC profiles. The rectangular frame 22 also preferably includes an extruded PVC central member 44 to add strength and stability to the frame 22. The horizontal lower rail 26 and upper rail 28, the left vertical side rail 30 and the central member are preferably glued and screwed together with plastic screws 46 (shown schematically) whereas the right vertical side rail 32 is only screwed but not glued to the horizontal lower rail 26 and upper rail 28 such that it can be removed as shown in FIG. 3 in order to insert the advertising sign panels 23 and 25 as shown in FIG. 4.

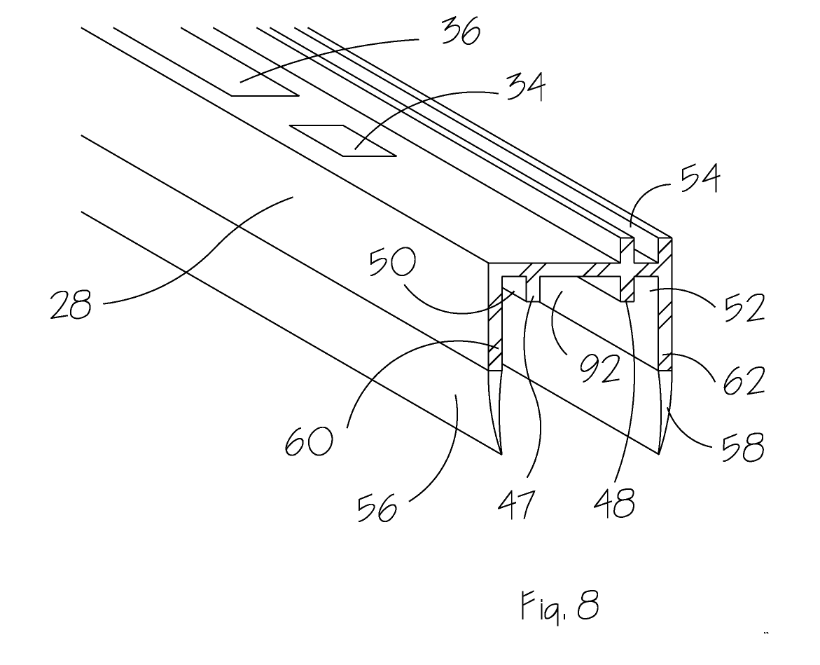

FIG. 3 illustrates the rectangular frame 22 with the right vertical side rail 32 removed. Referring now to FIG. 8 which is an enlarged view of the detail 8 of FIG. 3 showing the profile of the extruded horizontal upper rail 28, the extruded horizontal upper rail 28 is an inverted U-shaped profile having a pair of short projections 47 and 48 defining a pair of grooves 50 and 52 extending the entire length of the inner portion of the extruded upper rail 28. The profile of the extruded upper rail 28 also includes a groove 54 on the outer portion of the extruded upper rail 28 which is adapted to receive an additional small panel (not shown) above the point of sale signage system 20 to provide additional information concerning the property for sale. Weather strips 56 and 58 are connected to the end portions 60 and 62 of the inverted U-shaped profile of the extruded upper rail 28 to prevent water from seeping inside the rectangular frame 22 where the battery pack 42 and the lighting system 40 are.

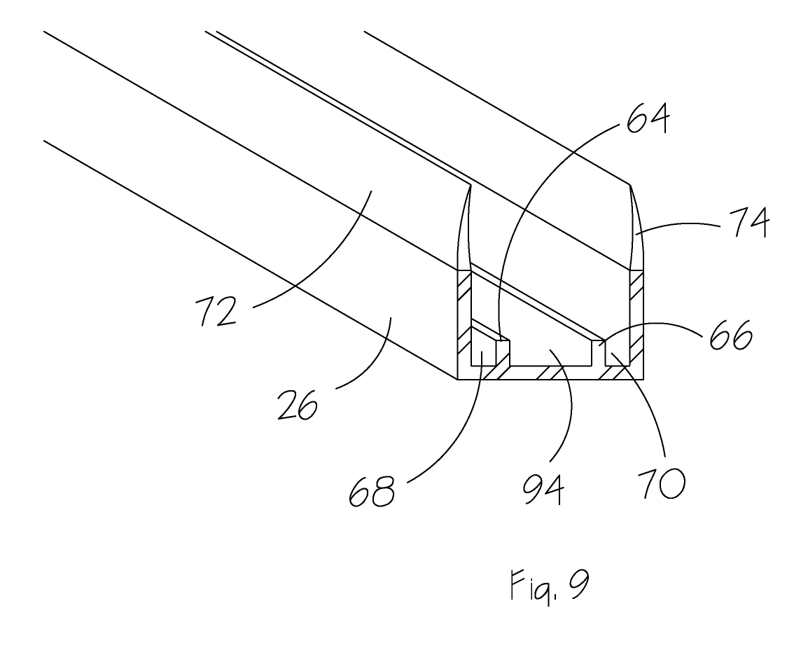

Referring now to FIG. 9 which is an enlarged view of the detail 9 of FIG. 3 showing the profile of the extruded horizontal lower rail 26, the extruded horizontal lower rail 26 is also a U-shaped profile having a pair of short projections 64 and 66 which define a pair grooves 68 and 70 extending the entire length of the inner portion of the extruded lower rail 26. Weather strips 72 and 74 are connected to the end portions of the U-shaped profile to prevent water from seeping inside the rectangular frame 22.

Referring back to FIG. 3, the groove 50 of the upper rail 28 is aligned with the groove 68 of the lower rail 26 and the groove 52 of the upper rail 28 is aligned with the groove 70 of the lower rail 26 thereby defining the upper and lower tracks for inserting and holding the advertising sign panels 23 and 25 and defining receptacle perimeters for receiving the advertising sign panels 23 and 25.

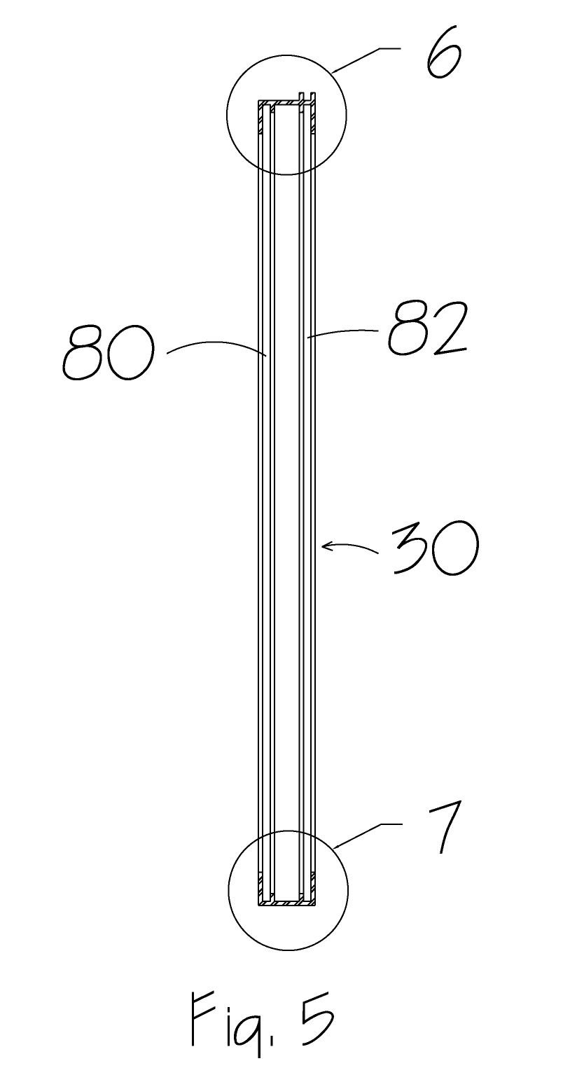

With reference to FIG. 4, the advertising sign panel 23 is inserted into the frontal grooves 50 and 68 of the upper and lower rails 28 and 26 respectively and slid all the way to the vertical left side rail 30 which is also provided with weather strips 76 and 78. Similarly, the advertising sign panel 25 is inserted into the rear grooves 52 and 70 of the upper and lower rails 28 and 26 respectively and slid all the way to the vertical left side rail 30. With reference to FIG. 5 illustrating the inside portion of the vertical side rail 30, the extruded profile of the vertical side rail 30 also includes a pair of grooves 80 and 82 into which the advertising sign panels 23 and 25 are inserted at the end of their paths. The advertising sign panels 23 and 25 are therefore held and secured in place by the grooves provided inside the extruded PVC frame 22. The weather-stripping incorporated into the extruded frame 22 serves a dual role of aiding in keeping the advertising sign panels 23 and 25 in place, and also, in preventing the elements from entering into the extruded frame 22, thereby creating a weatherproof seal.

Once the advertising sign panels 23 and 25 are inserted inside the grooves of the upper and lower rails 28 and 26 and of the vertical left side rail 30, the vertical right side rail 32 is secured back onto the ends of the upper and lower rails 28 and 26 via plastic screws 46 to close the rectangular frame 22.

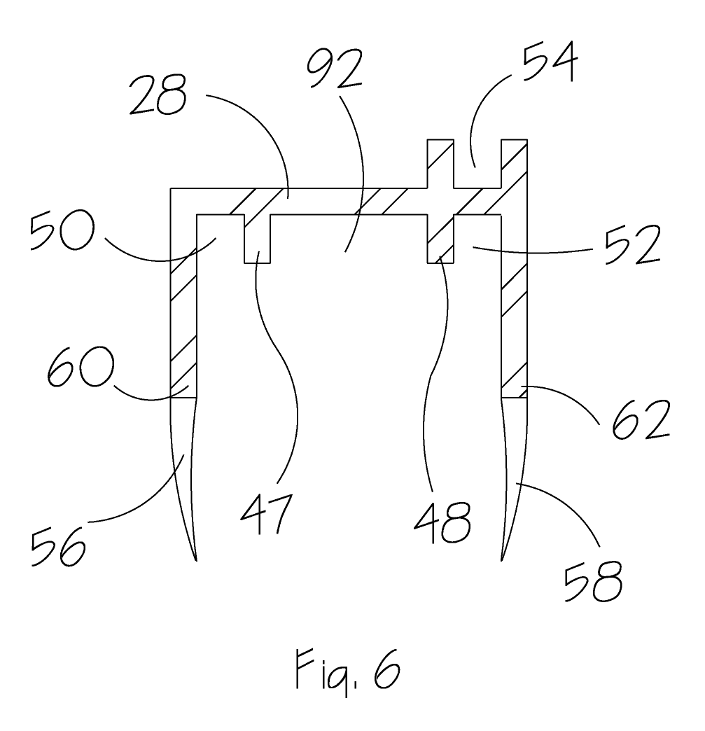

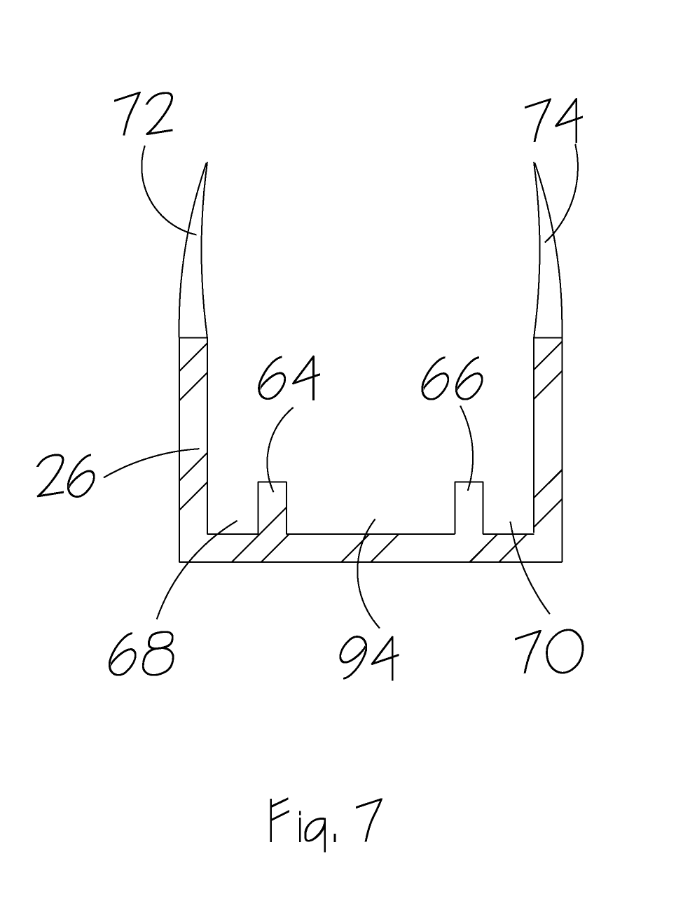

FIG. 6 is a cross section of the profile of the horizontal upper rail 28 with weather strips 56 and 58. The advertising sign panels 23 and 25 are inserted inside the grooves 50 and 52 respectively. Similarly, FIG. 7 is a cross section of the profile of the horizontal lower rail 26 with weather strips 72 and 74. The advertising sign panels 23 and 25 are inserted inside the grooves 68 and 70 respectively.

Referring now to FIG. 10, which is an inside view of the horizontal upper rail 28 taken at line 10-10 of FIG. 2, the lighting system 40 preferably includes a Light Emitting Diode (L.E.D.) strip positioned within the inner space 92 of the upper rail 28 located in between the grooves 50 and 52. LED can be adjusted in order to control the amount of light that is produced.

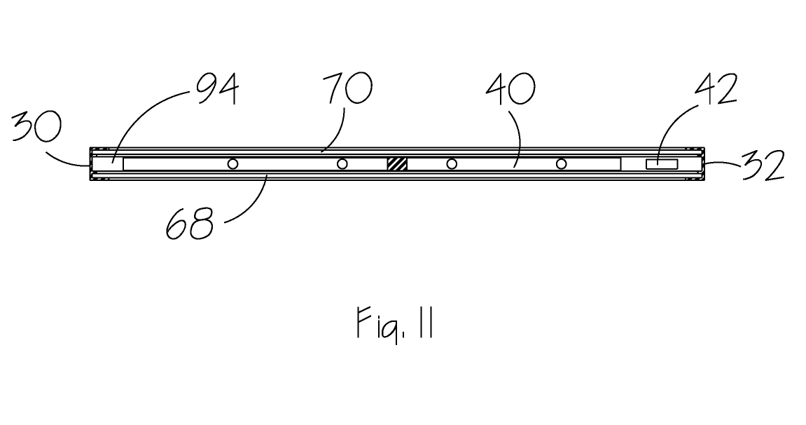

With reference to FIG. 11, which is an inside view of the horizontal lower rail 26 taken at line 11-11 of FIG. 2, a second Light Emitting Diode (L.E.D.) strip 40 is positioned within the inner space 94 of the lower rail 26 located in between the grooves 68 and 70. The battery pack 42 is also accommodated within a portion of the inner space 94 of lower rail 26 as illustrated.

Existing real estate signs are typically made of thin corrugated plastic or lexan, silk-screened that can be illuminated from the inside with the proper lighting system. The opacity of the material and colors of the existing sign determines how well the sign is illuminated. The point of sale signage system 20 in accordance with the invention is designed to receive existing real estate signs thereby considerably reducing the cost of manufacturing special advertising sign panels 23 and 25 for that purpose. The dimensions of the rectangular frame 22 and of the grooves of the horizontal lower and upper rails 26, 28 and of the vertical side rails 30, 32 defining the receptacle perimeters for the advertising sign panels 23 and 25 are chosen to accommodate the sizes and thicknesses of existing real estate signs. Furthermore, the intensity of illumination of the LED lighting system 40 is adjustable so as to accommodate the opacity of the material and colors of the existing real estate sign to be incorporated into the point of sale signage system 20 for optimal brightness. Furthermore, the LED lighting system 40 may also be of different of a variety of colors (red, yellow, green, blue, etc.) to increase the visual effect of the point of sale signage system 20.

In operation, the light sensor 34 controls the flow of power from the battery pack 42 to the LED lighting system 40. When the light sensor 34 senses that there is not enough exterior light, the light sensor sends a signal to the integrated circuit to allow power to flow from the battery pack 42 to the LED lighting system 40, alternatively, when the light sensor 34 senses that there is too much exterior light, the light sensor sends a signal to the integrated circuit to block the power flow from the battery pack 42 to the LED strips and the solar cell 36 starts charging the rechargeable battery pack, the integrated circuitry of the solar cell 36 turns off the charging process when the battery pack 42 is fully charged.

If a non-rechargeable battery pack is chosen as the power source, the solar cells 36 are simply not incorporated into the point of sale system 20.

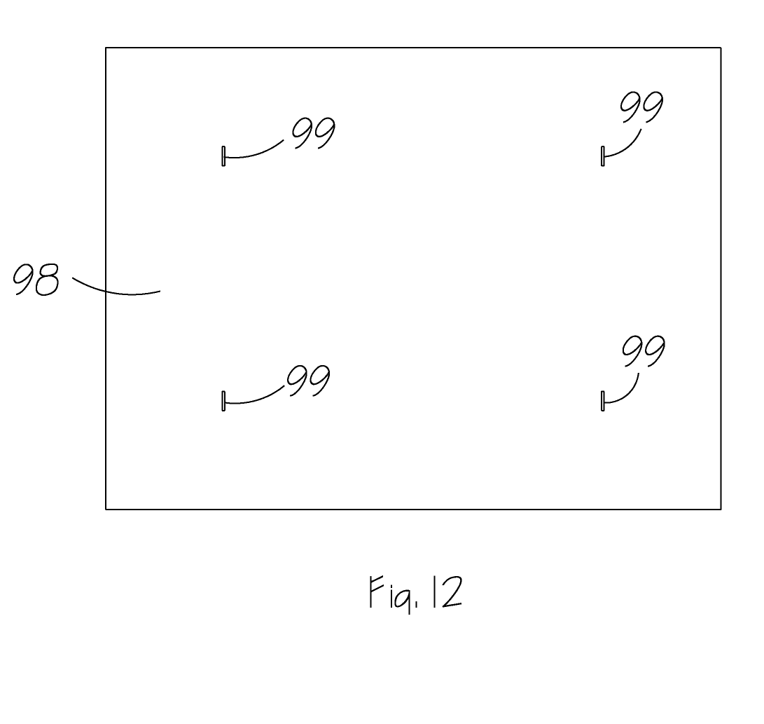

FIG. 12 illustrate a substitute rear panel 98 that can be used instead of the rear advertising sign panel 25 when only the front panel is to be illuminated. The substitute rear panel 98 includes a series of slats 99 integrated into the substitute rear panel 98 to allow for a fastening to suitable surfaces.

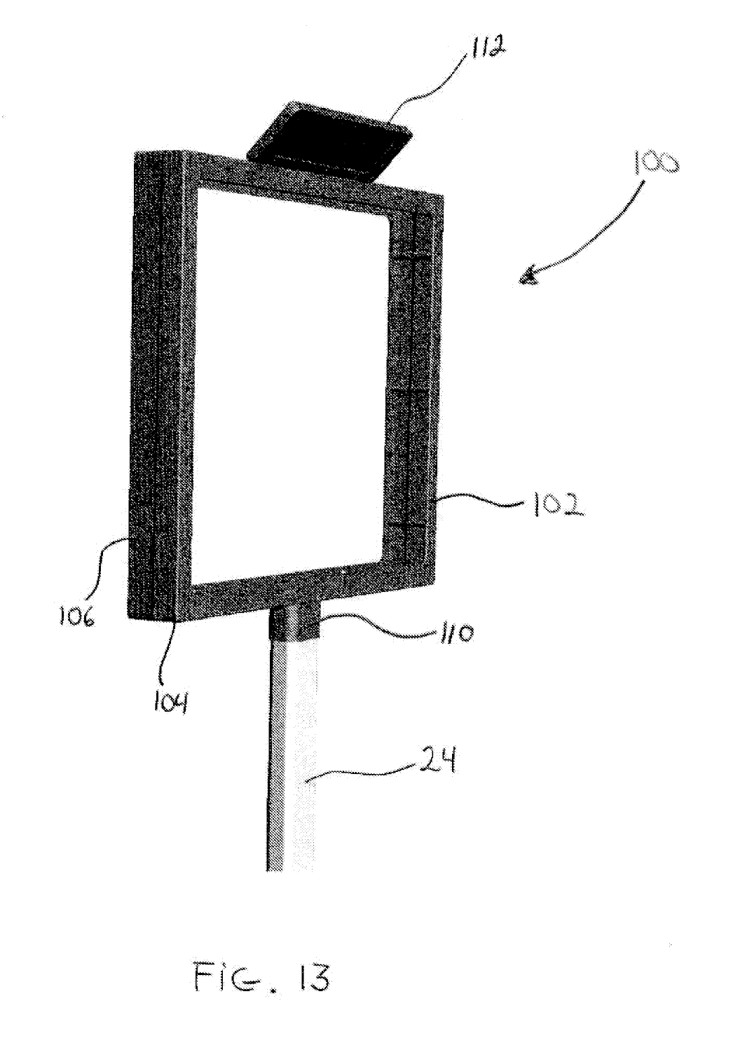

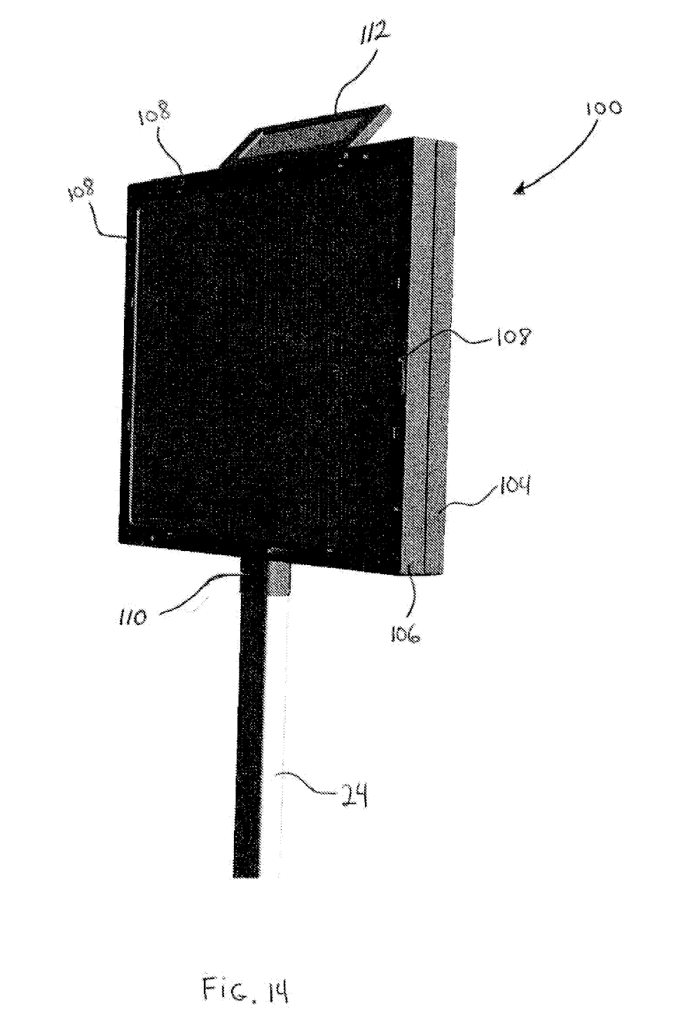

Referring now to FIGS. 13 and 14, there is shown a point of sale signage system 100 in accordance with one embodiment of the invention. The point of sale signage system 100 includes a rectangular molded frame 102 adapted to secure at least one advertising sign panel facing forward and optionally a second advertising sign panel facing in the opposite direction. The rectangular molded frame 102 includes a molded frontal portion 104 and a molded rear portion 106 which are mirror images of each other and are assembled together with fasteners 108 all around the structure to form the rectangular molded frame 102. The lower portion of the rectangular molded frame 102 includes a post fitting 110 for mounting the rectangular molded frame 102 onto a support post 24 in order to secure the point of sale signage system 100 to the ground. The point of sale signage system 100 is provided with a lighting system (not shown) located inside the rectangular frame 102 such that the front and rear advertising sign panels of the point of sale signage system 100 are illuminated at night. The point of sale signage system 100 includes a swivelling solar panel 112 having a light sensor (not shown) in order to turn on the lighting system only at night. The swivelling solar panel 112 is pivotally mounted to the rectangular frame 102 such that its angle may be adjusted in order to optimise its exposure to sun light. The solar panel 112 is connected to a battery pack located inside the rectangular frame 102 such that the battery pack may be charged by the solar panel 112 during the day. An integrated circuitry is provided between the light sensor, the solar panel 112, the lighting system and the battery pack which controls the charging process of the battery pack during the day and cuts off the charging process when the battery pack is fully charged so that the battery pack does not become overcharged. When there is insufficient light, the light sensor sends a signal to the integrated circuitry which in turn sends power from the battery pack to the lighting system located inside the rectangular frame 22 to illuminate the advertising sign panels of the point of sale signage system 100.

As previously mentioned, existing real estate advertising signs are not illuminated at night, thereby reducing their intended role because real estate signs are effective only when there is sufficient light available. The point of sale signage system 100 being illuminated when there is insufficient light available attracts attention of prospective buyer to the point of sale signage system 100 at night, thereby increasing the efficiency of the real estate advertising.

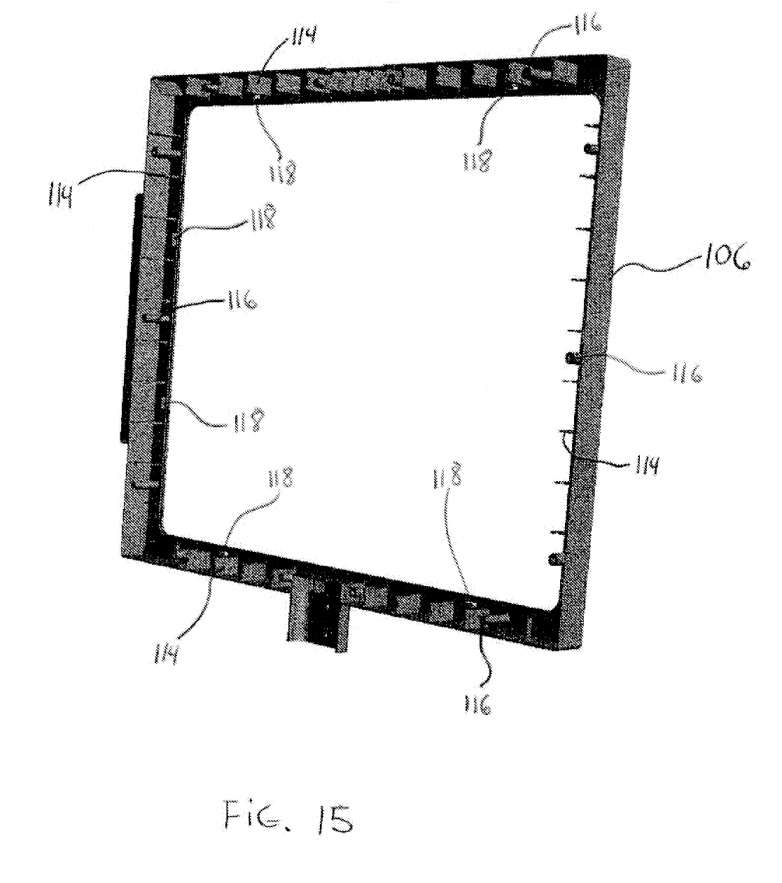

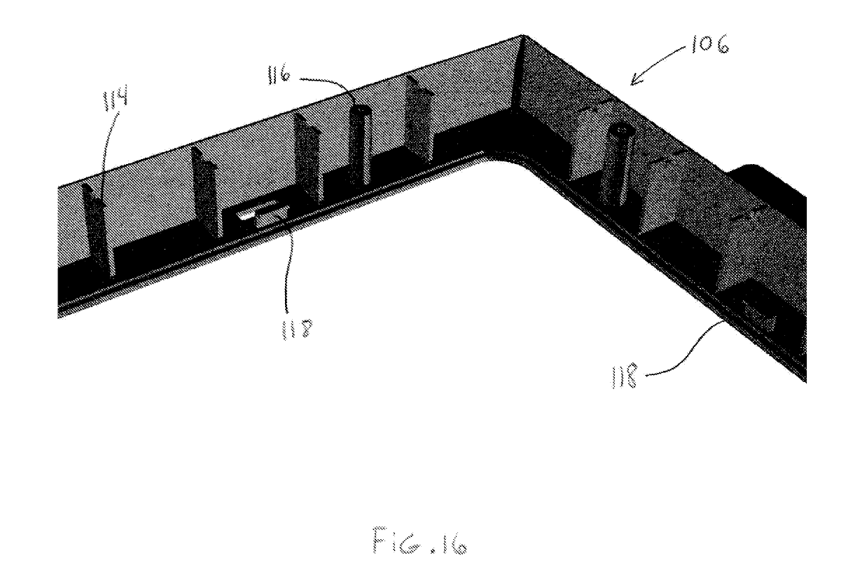

Referring now to FIGS. 15 and 16 showing the inner side of the molded rear portion 106 of the rectangular frame 102; the molded frontal portion 104 being a mirror image of the molded rear portion 106. The molded rear portion 106 includes a series of structural ribs 114 adapted to rigidify the rectangular frame 102. The molded rear portion 106 also includes a series of receptacles 116 for receiving the fasteners 108 when assembling the molded frontal portion 104 to the molded rear portion 106. The inner side of the molded rear portion 106 further includes a series of L-shaped projections 118 all around the molded rear portion 106 which together define a receptacle perimeter adapted to receive the edges of the advertising panels such the advertising panels are snapped onto position within the projections 118 of the front and rear molded portions 104, 106 and remain aligned with the rectangular frame 102 when the latter is assembled. The advertising panels are installed into the front and rear molded portions 104, 106 prior to assembling the front and rear molded portions 104, 106 and then the front and rear molded portions 104, 106 are assembled together via fasteners to form the rectangular frame 102. The rectangular frame 102 is then assembled to a support post 24 for installation on the ground. The rear advertising panel may be replaced with a substitute rear panel 98 for installation onto a vertical surface as previously described with reference to FIG. 12.

Preferably, the front and rear molded portions 104, 106 are fastened together with fasteners having a layer of adhesive such that the point of sale signage system 100 cannot be disassembled once assembled thereby protecting its internal components (battery pack 42, LED lighting system 40 and electronics) from theft. As well, the rectangular frame 102 is preferably locked onto the support post 24 to prevent theft.

The point of sale signage system 20 and 100 have been shown as a generally rectangular shape however, the point of sale signage system 20 and 100 may obviously be made in a variety of shapes and sizes. The point of sale signage system 20 and 100 may generally be used for residential, commercial and industrial purposes.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. An illuminated point of sale sign comprising: a frame, a lighting system and a battery electrically connected to the lighting system, the lighting system and the battery being disposed within the frame, and a light sensor disposed outside the frame and electrically connected to the lighting system and the battery; the frame including projections which define a receptacle perimeter adapted to receive and accommodate existing signs made of thin corrugated plastic or lexan.

2. An illuminated point of sale sign as defined in claim 1, further comprising a solar cell disposed above the frame and electrically connected to the battery for recharging the battery during daylight.

3. An illuminated point of sale sign as defined in claim 1, wherein the frame includes horizontal upper and lower rails and vertical side rails, each rail being an extruded profile including inner grooves which define the projections.

4. An illuminated point of sale sign as defined in claim 3, wherein one of the rails is removable for insertion and removal of the existing signs.

5. An illuminated point of sale sign as defined in claim 3, wherein the frame further comprises weather strips for sealing the frame from the elements when the existing signs are installed into the grooves.

6. An illuminated point of sale sign as defined in claim 3, wherein the frame comprises a pair of grooves to receive a front and a rear existing real estate sign.

7. An illuminated point of sale sign as defined in claim 1, further comprising a substitute rear panel adapted for attaching the point of sale sign to a vertical surface.

8. An illuminated point of sale sign as defined in claim 1, wherein the substitute rear panel includes a series of slats.

9. An illuminated point of sale sign as defined in claim 1, wherein the frame is a molded frame including a front molded portion and a rear molded portion fastened together.

10. An illuminated point of sale sign as defined in claim 10, wherein the front molded portion and the rear molded portion include L-shaped projections defining the receptacle perimeter of existing advertising signs.

11. An illuminated point of sale sign as defined in claim 1, wherein the solar cell disposed above the frame is pivotally mounted onto the frame.
